(19) United States
(12) Patent Application Publication
(10) Pub. No.: US 2026/0031923 A1
(43) Pub. Date: Jan. 29, 2026

(54) OPTICAL COMMUNICATION OF COMBINED HIGH-SPEED AND LOW-SPEED DATA

(71) Applicant: META PLATFORMS, INC., Menlo Park, CA (US)

(72) Inventors: Qing Wang, San Jose, CA (US); Han Wang, San Jose, CA (US)

(73) Assignee: META PLATFORMS, INC., Menlo Park, CA (US)

(21) Appl. No.: 19/275,926

(22) Filed: Jul. 21, 2025

Related U.S. Application Data
(60) Provisional application No. 63/674,674, filed on Jul. 23, 2024.

(51) Int. Cl. H04J 14/02; H04B 10/25

(52) U.S. Cl. CPC H04J 14/02; H04B 10/25

(57) ABSTRACT

A network device may combine high-speed optical signals with low-speed optical signals into an optical signal. The high-speed signals may include user data and the low-speed signals may include management data. By transmitting the combined high-speed optical signals and low-speed optical signals using an optical signal over an optical fiber, other protocols (e.g., Ethernet) may not be required. Alternatively, the optical signal, having both high-speed optical signals with low-speed optical signals, may be used as a backup or redundant transmission approach.

### CROSS-REFERENCE TO RELATED APPLICATION

This application claims the benefit of U.S. Application No. 63/674,674, filed Jul. 23, 2024, the entirety of which is incorporated by reference herein.

### TECHNICAL FIELD

This application is directed to optical communication, and more particularly, to using optical communication to combine high-speed data (e.g., user data) and low-speed data (e.g., management data) over the same optical fiber.

### BACKGROUND

Optical transceivers that are widely used in the fiber optic communication industry may only transmit and receive production traffic data. In some applications, neither the remote optics nor the end device may have out of band (OOB) Ethernet access. As a result, monitoring and managing these devices may incur challenges.

### BRIEF SUMMARY

Some examples of the present disclosure are directed to devices (e.g., networking devices, end user devices, edge devices, etc.) for communicating data, via optical communication, between computing devices, between servers, and/or between computing devices and servers.

In one example aspect, a system is provided. The system may include a first optical multiplexer configured to combine a first plurality of optical signals and provide a first multiplexed signal based on the combined first plurality of optical signals. The first plurality of optical signals may be in a first frequency range. The system may further include a second optical multiplexer configured to combine a second plurality of optical signals and provide a second multiplexed signal based on the combined second plurality of optical signals. The second plurality of optical signals may be in a second frequency range different from the first frequency range. The system may further include a wavelength-division multiplexer. The wavelength-division multiplexer may be configured to receive the first multiplexed signal. The wavelength-division multiplexer may be further configured to receive the second multiplexed signal. The wavelength-division multiplexer may be further configured to combine the first multiplexed signal with the second multiplexed signal. The wavelength-division multiplexer may be further configured to generate, based on combining the first multiplexed signal with the second multiplexed signal, a single optical signal.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Certain features of the subject technology are set forth in the appended claims. However, for purpose of explanation, several examples of the subject technology are set forth in the following figures.

FIG. 1 illustrates an example of a network device of a system in which data may be shared between devices, in accordance with example aspects of the present disclosure.

FIG. 2 illustrates a block diagram showing an alternate exemplary embodiment of a network device, in accordance with example aspects of the present disclosure.

FIG. 3 illustrates a block diagram showing an alternate exemplary embodiment of a network device, in accordance with example aspects of the present disclosure.

FIG. 4 illustrates a flowchart showing an exemplary process for transmitting data, in accordance with example aspects of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein.

The present disclosure is directed to using an optical communication network to combine high-speed signals and low-speed signals, thus allowing optical communication to transmit and receive high-speed signals and low-speed signals together. As non-limiting examples, high-speed data may include user data (e.g., video, web browsing, etc.) and low-speed data may include management data (e.g., control signals, reboot signals, forecast data, etc.). By integrating optical hardware (e.g., multiplexing hardware, de-multiplexing hardware, wavelength-division multiplexing hardware), the devices may communicate high-speed data and low-speed data through an optical fiber network. Moreover, a single fiber of the optical fiber network may carry both the high-speed data and low-speed data.

In some instances, when one or more networked devices may not be equipped with a network card (e.g., Ethernet card, wireless network card) and a network cable(s), only the optical communication channel may be available for communication, which in traditional systems is typically used for high-speed data. Alternatively, the network card and/or network cable(s) may be available but subsequently may become damaged or otherwise non-responsive. As a result, the networked devices may no longer be remotely monitored or controlled. In either event, additional cost in the form of technicians and/or new hardware, may be required.

However, by using the optical communication network of the exemplary aspects of the present disclosure, the low-speed data, used to provide management data, may be communicated with the high-speed data through an optical fiber. Moreover, the need for other network cards may not be required. Beneficially, optical communication networks described herein may be used as backup or a redundant communication channel.

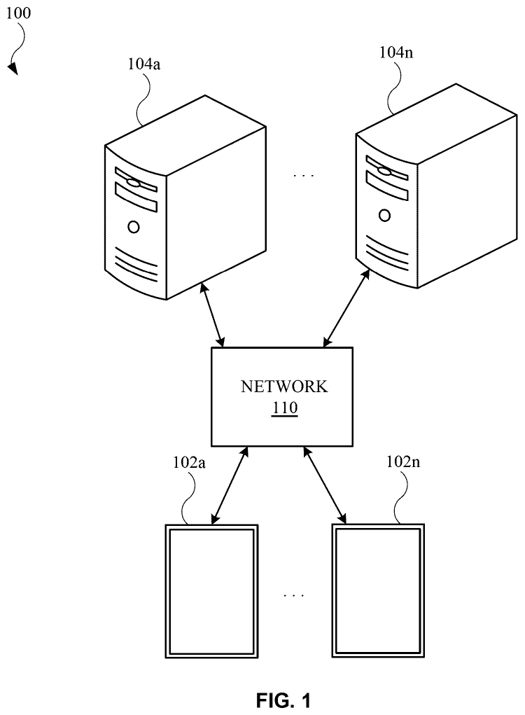

These and other embodiments are discussed below with reference to FIGS. 1-4. However, those skilled in the art will readily appreciate that the detailed description given herein with respect to these Figures is for explanatory purposes only and should not be construed as limiting.

FIG. 1 illustrates an example of a network device 100 of a system in which data may be shared between devices, in accordance with example aspects of the present disclosure. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

The network device 100 may include electronic devices (e.g., an electronic 102a and an electronic device 102n, representative of n electronic devices) and servers (e.g., a server 104a and a server 104n, representative of n servers). The network device 100 may further include a network 110 communicatively (directly or indirectly) coupled with one or more of the electronic devices 102a through 102n and one or more of the servers 104a through 104n. The electronic devices 102a through 102n may take the form of computing devices, such as desktop computing devices, laptop computing devices, cellular/mobile phones, smart tablets and/or the like. The servers 104a through 104n may take the form of devices that provide data, or information, to the electronic devices 102a through 102n.

In one or more implementations, the network 110 may be an interconnected network of devices that may include, or may be communicatively coupled to, the Internet. In the present disclosure, the network 110 may take the form of an optical network for communication between the electronic devices 102a through 102n and the servers 104a through 104n. For explanatory purposes, the network device 100 is illustrated in FIG. 1 as including the electronic devices 102a through 102n, the servers 104a through 104n, and the network 110. However, the network device 100 may include any number of electronic devices and/or any number of servers communicatively coupled to each other directly or via the network 110.

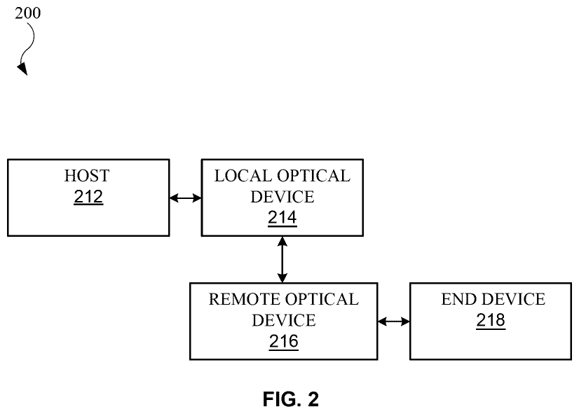

FIG. 2 illustrates a block diagram showing an alternate example embodiment of a network device 200, in accordance with example aspects of the present disclosure. As shown, the network device 200 may include a host 212, a local optical device 214, a remote optical device 216, and an end device 218.

As non-limiting examples, the host 212 and the end device 218 may take the form of a server (e.g., server 104a shown in FIG. 1) and an electronic device (e.g., electronic device 102a shown in FIG. 1), respectively. The local optical device 214 may be configured to convert electrical signals (e.g., from the host 212) to optical signals, and may provide the optical signals to the remote optical device 216. Additionally, the local optical device 214 is configured to convert optical signals (e.g., received from the remote optical device 216) to electrical signals, and may provide the electrical signals to the host 212. Similarly, the remote optical device 216 may be configured to convert optical signals (e.g., received from the local optical device 214) to electrical signals, and provide the electrical signals to the end device 218. Also, the remote optical device 216 may be configured to convert electrical signals (e.g., from the end device 218) to optical signals, and may provide the optical signals to the local optical device 214.

In some instances, the remote optical device 216 and the end device 218 may, but need not, be relatively far from the host 212. Further, in some examples at least one of the remote optical device 216 and the end device 218 may not be equipped for OOB access. As a result, monitoring and/or managing the remote optical device 216 and the end device 218 through means (e.g., telemetry) may be difficult.

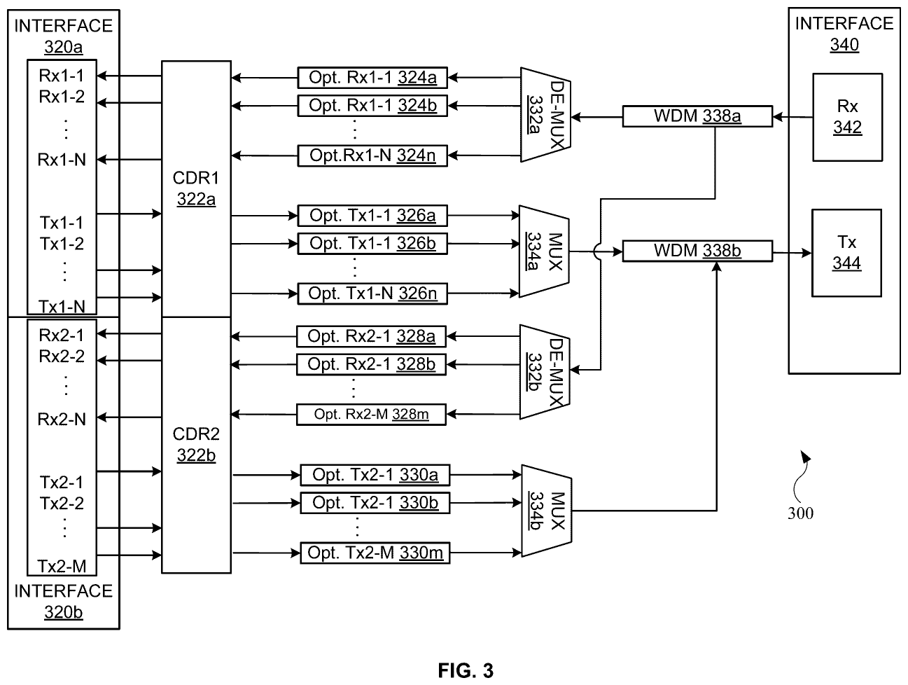

FIG. 3 illustrates a block diagram showing an alternate exemplary embodiment of a network device 300, in accordance with example aspects of the present disclosure. In one or more implementations, the network device 300 may take the form of an optical communication network. The network device 300 may be used to place electronic devices and/or servers (e.g., shown in FIG. 1) in communication with each other.

As shown, the network device 300 may include an interface 320a and an interface 320b. In one or implementations, the interface 320a takes the form of a data interface, including a high-speed data interface. This may include a high-speed electrical interface. The interface 320 may be designed to communicate data approximately in the range of 100 to 400 Gigabits per second (Gbps). Conversely, in one or implementations, the interface 320b may take the form of a data interface, including a low-speed data interface. This may include a low-speed electrical interface. The interface 320b is designed to communicate data at approximately 1 Gbps or less. Each of the interfaces 320a and 320b may include several transmitters and receivers. For example, the interface 320a may include N receivers and N transmitters, where N is an integer. Also, the interface 320b may include M receivers and M transmitters, where M is an integer. Based on the receiving and transmitting capabilities, each of the interfaces 320a and 320b may function as transceivers.

The network device 300 may further include a clock data recovery (CDR) device 322a and a clock data recovery device 322b, denoted by CDR1 and CDR2 respectively in FIG. 3. The clock data recovery devices 322a and 322b may be designed to perform domain shaping and clock recovery. Also, the clock data recovery device 322a and the clock data recovery device 322b are electrically connected to the interface 320a and the interface 320b, respectively. In this regard, one or more electrical interfaces (e.g., pins, wires) may be used to provide electrical connections between the interfaces 320a and 320b and the clock data recovery devices 322a and 322b. The clock data recovery device 322a may communicate with the interface 320a by sending, to the N receivers, electrical signals, and receiving, via the N transmitters, electrical signals. Similarly, the clock data recovery device 322b may communicate with the interface 320a by sending, to the M receivers, electrical signals, and receiving, via the M transmitters, electrical signals.

The network device 300 may further include several optical receivers and optical transmitters. For example, the network device 300 may include an optical receiver 324a (Opt. Rx1-1), an optical receiver 324b (Opt. Rx1-2), and an optical receiver 324n (Opt. Rx1-N), representing N optical receivers. The network device 300 may further include an optical transmitter 326a (Opt. Tx1-1), an optical transmitter 326b (Opt. Tx1-2), and an optical transmitter 326n (Opt. Tx1-N), representing N optical transmitters. Additionally, the network device 300 may include an optical receiver 328a (Opt. Rx2-1), an optical receiver 328b (Opt. Rx2-2), and an optical receiver 328n (Opt. Rx2-M), representing M optical receivers, as well as an optical transmitter 330a (Opt. Tx2-1), an optical transmitter 330b (Opt. Tx2-2), and an optical transmitter 330m (Opt. Tx2-M), representing M optical transmitters.

At least some of the optical transmitters and optical receivers may carry data at different speeds, and accordingly may operate in different wavelength bands associated with fiber optic communication. For example, the N optical receivers (e.g., optical receivers 324a, 324b, and 324n) and the N optical transmitters (e.g., optical transmitters 326a, 326b, and 326n) may receive and transmit high-speed data based on communication with the interface 320a (e.g., high-speed interface) via the clock data recovery device 322a. In this regard, the N optical receivers (e.g., optical receivers 324a, 324b, and 324n) and the N optical transmitters (e.g., optical transmitters 326a, 326b, and 326n) may operate in the O-band (e.g., approximately in the range of 1260 nanometers (nm) to 1360 nm) with an associated frequency being inversely proportional to the wavelength. Accordingly, data transmission in the O-band range may have a frequency range (and range of speeds) based on the wavelength range.

Conversely, the M optical receivers (e.g., optical receivers 328a, 328b, and 328m) and the M optical transmitters (e.g., optical transmitters 330a, 330b, and 330m) may receive and transmit low-speed data based on communication with the interface 320b (e.g., low-speed data interface) via the clock data recovery device 322b. In this regard, the M optical receivers (e.g., optical receivers 328a, 328b, and 328m) and the M optical transmitters (e.g., optical transmitters 330a, 330b, and 330m) may operate in the C-band (e.g., approximately in the range of 1530 nm to 1565 nm) with an associated frequency being inversely proportional to the wavelength. Accordingly, data transmission in the C-band range may have a frequency range (and range of speeds) based on the wavelength range. While the exemplary embodiments discloses the use of two bands, in other implementations, multi-wavelength (and accordingly, multi-frequency) bands in addition to C-band and O-band may be used (e.g., E-band, S-band, L-band).

By comparison, the optical signals for the described high-speed data and low-speed data may have different wavelength ranges and frequency ranges. For example, the O-band range may include a lower wavelength range and higher frequency range (and associated higher range of speed) than the optical signals in the C-band, which may include a higher wavelength range and lower frequency range (and associated lower range of speed). Further, based on the wavelengths being non-overlapping, the high-speed data and low-speed data may include non-overlapping frequencies and non-overlapping ranges of speed.

The network device 300 may further include a demultiplexer 332a (DE-MUX), a multiplexer 334a (MUX), a demultiplexer 332b (DE-MUX), and a multiplexer 334b (MUX). In one or more implementations, each of the demultiplexers 332a and 332b may take the form of an optical demultiplexer. In this regard, each of the demultiplexers 332a and 332b may separate an optical signal into multiple optical signals. This may include altering the light from an incoming optical signal with a color light into multiple optical signals with different colors of light. In one or more implementations, each of the multiplexers 334a and 334b may take the form of an optical multiplexer. In this regard, each of the multiplexers 334a and 334b may combine multiple optical signals into an optical signal. This may include combining multiple optical signals with different colors of light into a single optical signal with a single color of light.

As shown, the N optical receivers (e.g., optical receivers 324a, 324b, and 324n) are coupled (e.g., optically coupled) with the demultiplexer 332a and with the clock data recovery device 322a, and the N optical transmitters (e.g., optical transmitters 326a, 326b, and 326n) are coupled (e.g., optically coupled) with the multiplexer 334a and with the clock data recovery device 322a. Also, the M optical receivers (e.g., optical receivers 328a, 328b, and 328m) are coupled (e.g., optically coupled) with the demultiplexer 332b and with the clock data recovery device 322b, and the M optical transmitters (e.g., optical transmitters 330a, 330b, and 330m) are coupled (e.g., optically coupled) with the multiplexer 334a and with the clock data recovery device 322b.

The network device 300 may further include a wavelength-division multiplexer 338a (WDM) and a wavelength-division multiplexer 338b (WDM). Each of the wavelength-division multiplexers 338a and 338b may multiplex multiple optical signals and may transmit the multiplexed optical signal over an optical fiber. As shown, the wavelength-division multiplexer 338a is coupled (e.g., optically coupled) with each of the demultiplexers 332a and 332b, and the wavelength-division multiplexer 338b is coupled (e.g., optically coupled) with each of the multiplexers 334a and 334b.

The network device 300 may further include an interface 340. In one or more implementations, the interface 340 may take the form of an optical interface. Accordingly, the interface 340 may include one or more fiber optic connectors, as a non-limiting example. As shown, the interface 340 may include a receiver (Rx) 342 and a transmitter (Tx) 344, which may take the form of an optical receiver and an optical transmitter, respectively. The receiver 342 and the transmitter 344 may couple (e.g., optically couple) with the wavelength-division multiplexer 338a and the wavelength-division multiplexer 338b, respectively. Also, the receiver 342 and the transmitter 344 may receive and transmit, respectively, both high-speed optical signals and low-speed optical signals. Based on the receiving and transmitting capabilities, the interface 340 may function as a transceiver.

Based on the described architecture, high-speed electrical signals and low-speed electrical signals received from the interface 320a and the interface 320b, respectively, may be converted to high-speed optical signals and low-speed optical signals, respectively. For example, the clock data recovery device 322a and the clock data recovery device 322b may convert the high-speed electrical signals and the low-speed electrical signals, respectively. The high-speed optical signals and low-speed optical signals may subsequently be provided to the multiplexer 334a and the multiplexer 334b, respectively. Based on the optical connections, the wavelength-division multiplexer 338b may generate a signal by combining multiplexed, high-speed optical signals (provided by the multiplexer 334a) with multiplexed, low-speed optical signals (provided by the multiplexer 334b) into a single optical signal that is provided to the transmitter 344 of the interface 340 for optical transmission to another device. For example, the multiplexed, high-speed optical signals and low-speed optical signals may include different wavelengths of light, and accordingly, different colors of light. The wavelength-division multiplexer 338b may combine the high-speed optical signals and low-speed optical signals into a different (e.g., single) color, and may provide the combined optical signal, in the different color, to the transmitter 344, where the interface 340 may transmit the combined optical signal.

Through this binding operation, the network device 300 may combine data such as user data (e.g., high speed signals including memory, cache, network packet, etc.) with management data (e.g., control signals, reset signals, forecast signals, management bus, status, clock, etc.), and may provide the combined user data and management data in an optical signal over an optical fiber. This may include providing the combined data as a single optical signal over a single optical fiber. Beneficially, devices (e.g., servers, computing devices, etc.) may efficiently provide both user data and management data without the use of other protocols (e.g. Ethernet), and the high-speed data may not need to be isolated from the low-speed data. As a result, devices connected to the network device 300 may nonetheless transmit and receive high-speed data and low-speed data even when another protocol (e.g., Ethernet) is unavailable or inoperable. This may lead to a lower cost management and more network efficient approach.

Additionally, the wavelength-division multiplexer 338a may receive high-speed optical signals and low-speed optical signals via the receiver 342 of the interface 340. The wavelength-division multiplexer 338a may separate the high-speed signals and low-speed signals and may provide the high-speed optical signals to the demultiplexer 332a, and further may provide the low-speed signals to the demultiplexer 332b. The high-speed optical signals may be then provided to the N optical receivers (e.g., optical receivers 324a, 324b, and 324n) and the low-speed signals may then be provided to the M optical receivers (e.g., optical receivers 328a, 328b, and 328n). The clock data recovery device 322a and the clock data recovery device 322b may receive the high-speed data and the low-speed data, respectively. The clock data recovery device 322a may convert the high-speed optical signals to high-speed electrical signals and may provide the high-speed electrical signals to the interface 320a (e.g., the receivers Rx1-1 through Rx1-N). The clock data recovery device 322b may convert the low-speed optical signals to low-speed electrical signals and may provide the low-speed electrical signals to the interface 320b (e.g., the receivers Rx2-1 through Rx2-M). Thus, based in part on the wavelength-division multiplexer 338a, the network device 300 may also manage separating a single optical signal into high-speed optical signals and low-speed optical signals, which may be converted to a high-speed electrical signal(s) and a low-speed electrical signal(s), respectively.

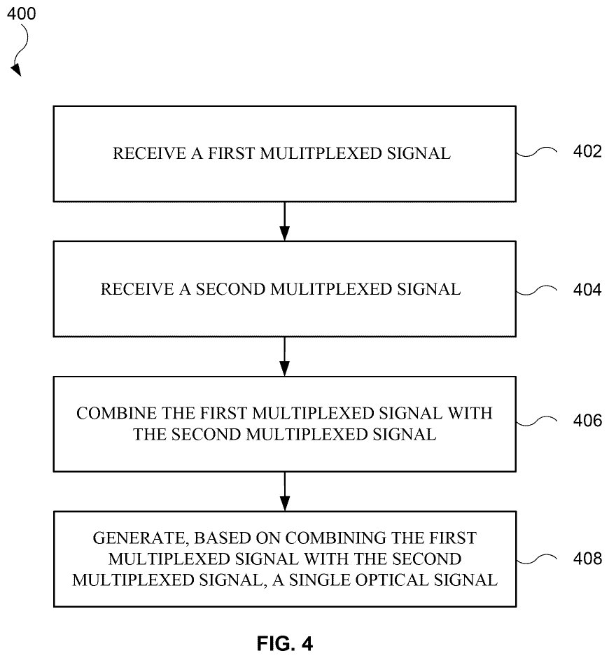

FIG. 4 illustrates an exemplary flowchart showing a process 400 for transmitting data, in accordance with example aspects of the present disclosure. One or more network devices (e.g., the network device 300 shown in FIG. 3) may carry out or perform the blocks described below.

At block 402, a first multiplexed signal may be received. The first multiplexed signal may include a multiplexed optical signal representing a combination of optical signals within a first frequency range, or first range of speeds. These optical signals may be converted from electrical signals.

At block 404, the second multiplexed signal may be received. The second multiplexed signal may include a multiplexed optical signal representing a combination of optical signals within a second frequency range, or second range of speeds. The second frequency range may be different from the first frequency range. These optical signals may be converted from electrical signals.

At block 406, combine the first multiplexed signal with the second multiplexed signal are combined. In one or more implementations, the first multiplexed signal and the second multiplexed signal are combined using a wavelength-division multiplexer (e.g., wavelength-division multiplexer 338b shown in FIG. 3).

At block 408, based on combining the first multiplexed signal with the second multiplexed signal, a single optical signal may be generated. The single optical signal may represent an optical signal with both the high-speed optical signals and the low-speed optical signals. The single optical signal may be carried by a single optical fiber.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary,” as used herein, is not provided to convey any qualitative assessment, but instead merely to convey an illustration of an example. Thus, use of any such terms should not be taken to limit the spirit and scope of embodiments of the present application. It is to be understood that the methods and systems described herein are not limited to specific methods, specific components, or to particular implementations.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only, and is not intended to be limiting.

It is to be appreciated that certain features of the disclosed subject matter which are, for clarity, described herein in the context of separate embodiments, can also be provided in combination in a single embodiment. Conversely, various features of the disclosed subject matter that are, for brevity, described in the context of a single embodiment, can also be provided separately, or in any sub-combination. Further, any reference to values stated in ranges includes each and every value within that range. Any documents cited herein are incorporated herein by reference in their entireties for any and all purposes.

It is to be understood that the methods and systems described herein are not limited to specific methods, specific components, or to particular implementations. It is also to be understood that the terminology used herein is for the purpose of describing particular embodiments only and is not intended to be limiting.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim. References in this description to “an example”, “one example”, or the like, may mean that the particular feature, function, or characteristic being described is included in at least one example of the present embodiments. Occurrences of such phrases in this specification do not necessarily all refer to the same example, nor are they necessarily mutually exclusive.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A system comprising:
a first optical multiplexer configured to combine a first plurality of optical signals and provide a first multiplexed signal based on the combined first plurality of optical signals, wherein the first plurality of optical signals are in a first frequency range;
a second optical multiplexer configured to combine a second plurality of optical signals and provide a second multiplexed signal based on the combined second plurality of optical signals, wherein the second plurality of optical signals are in a second frequency range different from the first frequency range; and
a wavelength-division multiplexer configured to:
receive the first multiplexed signal;
receive the second multiplexed signal;
combine the first multiplexed signal with the second multiplexed signal; and
generate, based on combining the first multiplexed signal with the second multiplexed signal, a single optical signal.

2. The system of claim 1, wherein the first frequency range is non-overlapping with the second frequency range.
